(19) United States
(12) Patent Application Publication
(10) Pub. No.: US 2006/0213943 A1
(43) Pub. Date: Sep. 28, 2006

(54) Character harness with storage pouch

(75) Inventors: Katherine Gold, Denver, CO (US); Lynn Rosen, Parker, CO (US)

Correspondence Address: John E. Reilly, 1554 Emerson Street, Denver, CO, 80218, US

(73) Assignee: Gold Bug, Inc.

(21) Appl. No.: 11/090,808

(22) Filed: Mar. 25, 2005

(51) Int. Cl. A45C 15/00; A62B 35/00; B60R 22/00

(52) U.S. Cl. 224/576; 224/153; 119/770

(57) ABSTRACT

A child's harness including a storage pouch and in the form of a novelty character, the limbs of the character forming shoulder straps and a waist strap of the harness. The harness is secured with waist and shoulder strap closure members so that it is not easily removable by the wearer.

### BACKGROUND AND FIELD OF INVENTION

This invention relates to a child's harness; and more particularly to a character harness that is also a backpack wherein the body portion of the harness is in the form of a novelty character of animal or human form to define a storage pouch, the shoulder and waist straps of the harness representing the limbs or extremities of the character, and a tether attached to the harness in the form of a character tail.

Prior art patents include a number of child harness systems where the child harness is adjustable in the rear at the waist member and the shoulder straps extend solely from the same waist member making the harness uncomfortable to the wearer. Further, many children object to wearing a harness. Prior to the present invention, there has been no satisfactory harness which is comfortable and capable of restraining a child who is walking and at the same time providing a novelty carrier or backpack which encourages use by the child.

### SUMMARY OF THE INVENTION

Accordingly, it is an object of the present invention to provide a harness that is adjustable from the front.

It is another object of the present invention to provide an improved harness that prevents a child from easily removing the harness.

It is another object of the present invention to provide for a harness which includes a carrier backpack in the shape of a novelty character.

It is a further object of the present invention to provide for a harness having a storage pouch.

It is a further object of the present invention to provide for a child harness that allows for easy adjustment of the harness as well as attachment of the tether to facilitate walking.

It is a final object of the present invention to provide for a child harness that encourages a child to wear the harness.

In accordance with the present invention, there is provided a child harness including a fabric shell defining a body portion of a character having a head and pairs of upper and lower limb members extending outwardly from the body portion, upper limb members forming shoulder strap members to be worn over the shoulders of a wearer, lower limb members forming waist strap members to encircle the waist of a wearer and upper and lower members being secured to form a restraint member. The shoulder straps and waist straps are adjustable and the harness includes a detachable tether in the form of a character tail.

The above and other objects, advantages and features of the present invention will become more readily appreciated and understood from a consideration of the following detailed description of preferred and modified forms of the present invention when taken together with the accompanying drawings in which:

### BRIEF DESCRIPTION OF THE DRAWINGS

FIG. 1 is a perspective view of a preferred embodiment of the harness/backpack in the shape of an animal on the shoulders of a wearer;

FIG. 2 is a rear elevational view of a preferred embodiment of the harness of the present invention;

FIG. 3 is a front elevational view of a preferred embodiment of the present invention;

FIG. 4 is a top plan view of a preferred embodiment of the harness of the present invention;

FIG. 5 is a bottom plan view of a preferred embodiment of the harness of the present invention;

FIG. 6 is a side view of a preferred embodiment of the harness of the present invention;

FIG. 7 is an opposite side view of the view shown in FIG. 6; and

FIG. 8 is a cross-sectional view taken about lines 8-8 of FIG. 7 of the harness of the present invention.

### DETAILED DESCRIPTION OF PREFERRED EMBODIMENT

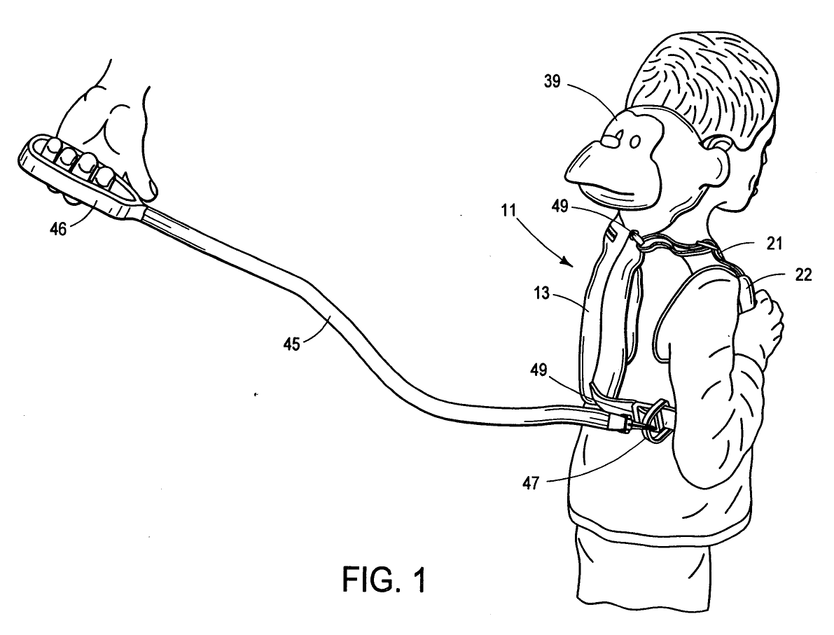

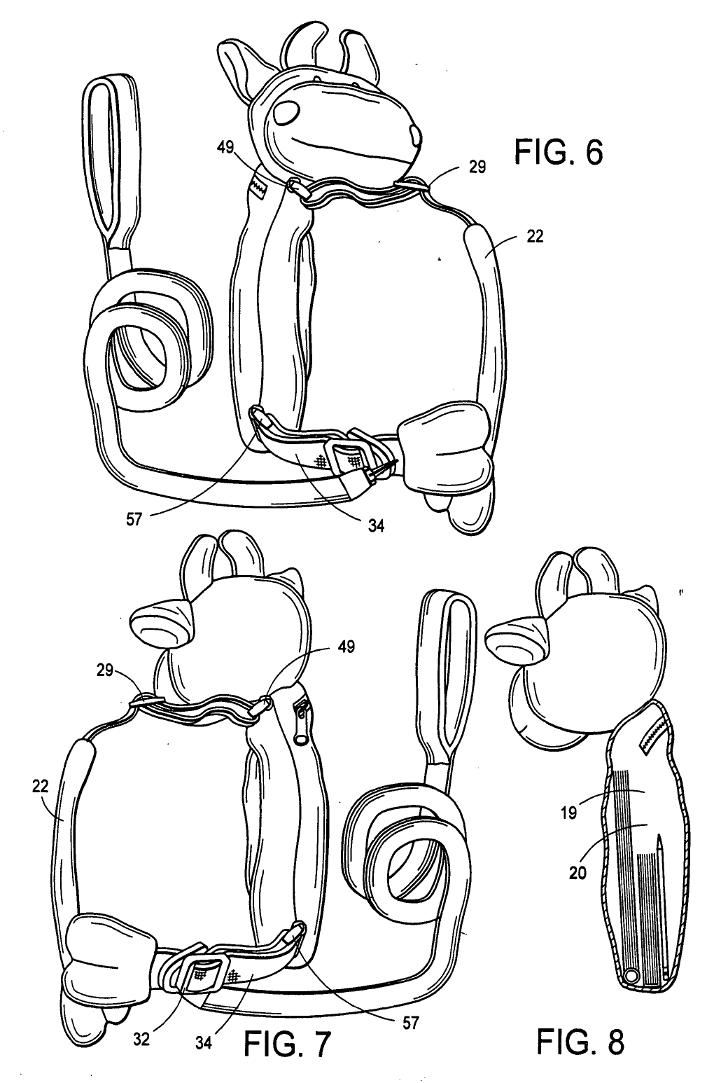

As shown in FIGS. 1 through 8 and more particularly in FIGS. 1-3, there is demonstrated a character harness 11 in the form of a novelty character in use on a wearer, specifically a child. The device 11 includes a body portion or member 13 which is defined by an outer fabric shell 14 having a back panel 15, a front panel 17 and a storage member which is in the form of a pouch 19 as shown in FIG. 8. A head member 39 is attached to an upper portion 18 of the body 13 and may be in the form of a human or animal head and torso. Shoulder strap members 21 are designed to be worn over the shoulder of a wearer, typically a child and are attached to the body or torso portion 13. A waist strap member 23 also extends from the body portion 13 and the combination of the shoulder strap members 21, the waist strap member 23 and the body portion 13 form a harness/backpack with the shoulder strap members 21 and the waist strap member 23 forming limbs or extremities of the character.

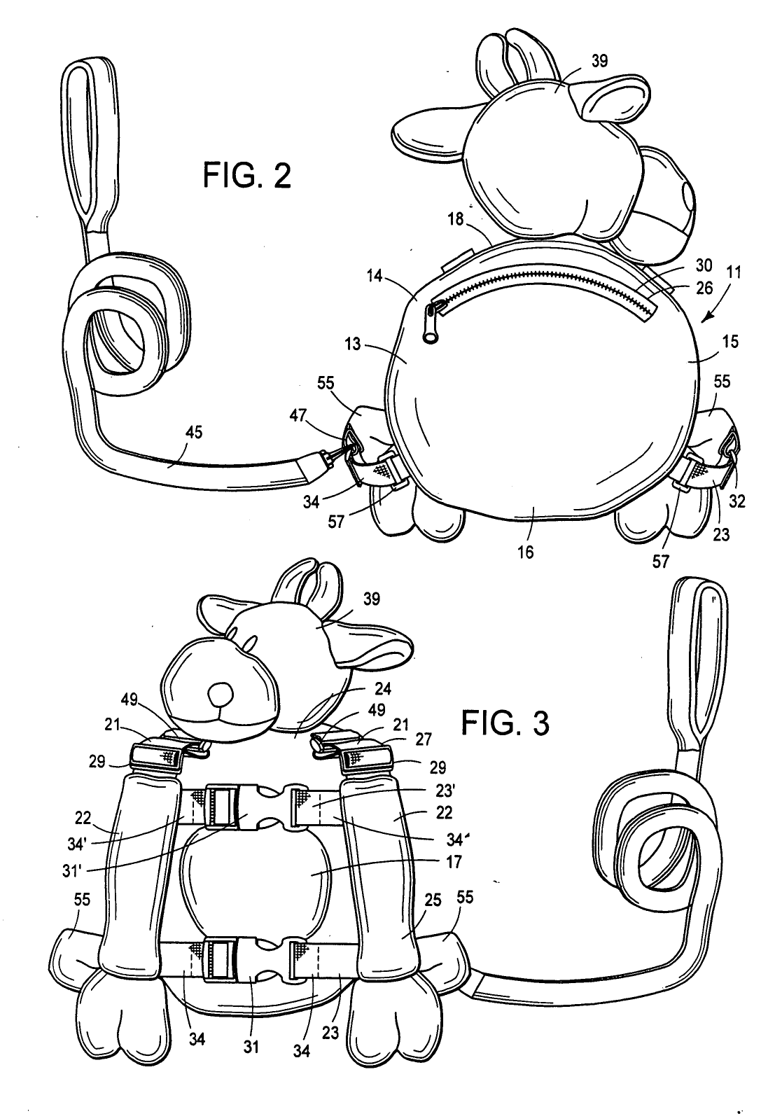

The outer shell 14 of the body portion 13 is composed of a soft fabric, either cotton or polyester, and has a rounded shape. The back panel 15 and the front panel 17 are sewn together and there is a pouch or storage member 19 in an upper portion 18 of the back panel 15. The pouch 19 has an interior portion 20 which is capable of holding small articles, such as, small toys or other miscellaneous items as shown in FIG. 8. An opening 26 in the pouch 19 may be closed with a zipper 30 or any other type of closure device. Attached to the body portion 13 along an upper portion 24 of the front panel are the shoulder strap members 21. The shoulder strap members 21 are preferably nylon straps connected to the upper portion 24 of the front panel 17 with plastic loop retainers 49 shown in FIGS. 1, 3, 6 and 7. Upper ends 27 of the shoulder strap members 21 each contain an adjustment device 29 which is formed of plastic or any other rigid material and allows for lengthening or shortening of the shoulder straps 21. Depending upon the size of the wearer, the harness may be easily adjusted to snugly fit around the shoulders and torso of the wearer. Cushioning members 22 are secured around the shoulder strap members 21 below the adjustment devices 29. The cushioning members 22 are formed of a soft material, such as, cotton or polyester and contain a moderate amount of fill or stuffing so that they are slightly padded. The cushioning members 22 form a padded area along the chest area of the wearer providing for a comfortable fit. Terminal or lower ends 25 of the shoulder strap members 21 are secured to the waist strap member 23 which includes two nylon side straps 34 attached with plastic loop retainers 57 to opposite sides of and extending forwardly from the lower body 16. See FIGS. 2 and 5. The lower ends or hands 25 of the shoulder strap members 21 are attached to each waist strap member 34 adjacent to a waist closure member 31 which will be discussed in more detail. The straps 34 extend from a lower portion 16 of the body portion 13 and are designed to partially encircle the waist of a user. This is shown in FIGS. 2, 5, 6 and 7. Each strap 34 has an adjustment device 32 which allows for shortening or lengthening of each waist strap member 34. The dual waist strap members 34 are attached together at terminal ends with the waist closure member 31, preferably a quick release latch. The waist strap members 34 have a cushioned portion 55 which is located between the waist adjustment member 32 and the closure member 31. As described previously, the cushioning portion 55 is made of a soft supple material which is lightly padded. The cushioned portion prevents undue rubbing of the waist straps along the waist area of a wearer. An upper strap member 23′ extends between the shoulder strap members 21 and partially encircles or spans the midsection of the body 13 in the same manner as the waist strap 23 and like parts are correspondingly enumerated. The upper strap member 23′ includes two nylon straps 34′ which are attached together at terminal ends with a closure member 31′. The upper and lower waist closures 31 and 31′ are aligned so that the device 11 is securely fastened around the torso and chest of a user forming a restraining unit. The upper strap member 23′ prevents a child from slipping out of the harness or removing the shoulder straps 21. The location of the body portion 13 and the connection between the shoulder strap members 21 and the body portion 13, as well as the extension of the waist straps 34 from the lower portion 16 of the body portion 13 provides for a harness 11 which is easy to adjust and is less likely to become tangled. Further, the shoulder straps 21 in combination with the upper and lower straps 23 and 23′ provide for a comfortable harness.

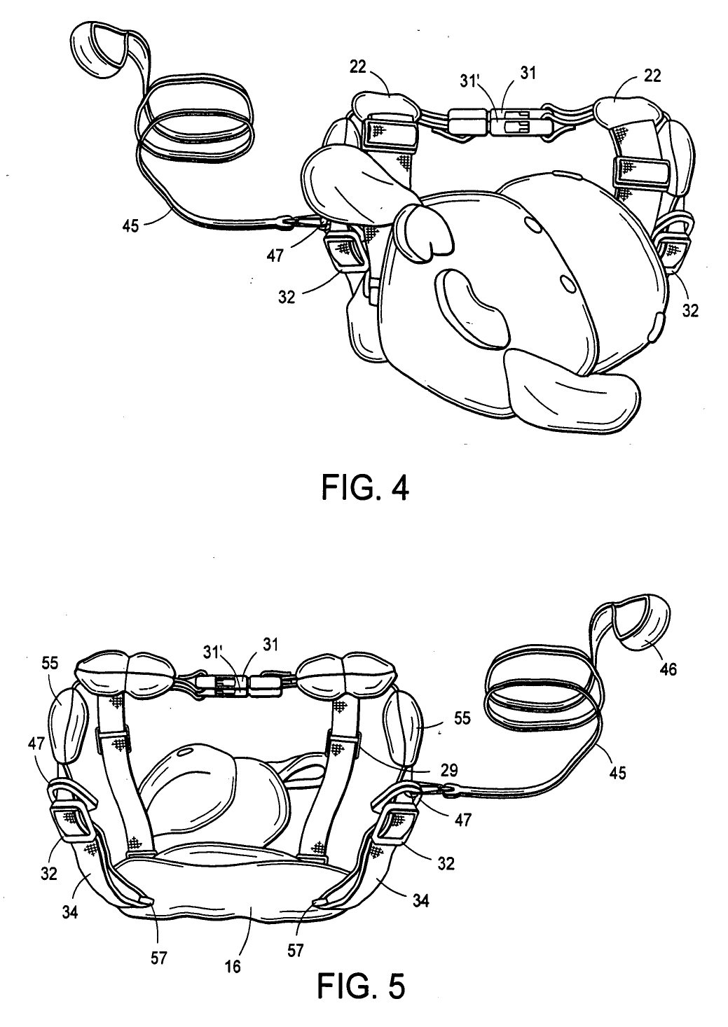

The waist strap 23 also includes at least two tether members 47, as shown in FIGS. 4 and 5, which are formed of plastic and are in the form of a link or loop. A tether 45 may be attached to the tether loop 47 with a tether hook 49. The tether 45 is preferably in the form of a long strip of material with a handle portion 46. An opposite end 48 of the tether 45 contains the tether hook 49. The tether 45 should be of sufficient length to allow a child or wearer who is linked to the tether by the device 11 enough length to freely move around but short enough to allow a parent grasping the tether handle 46 to prevent tangling and loss of control of the child.

Attached to the upper portion 18 of the body portion 13 is the head member 39 which is preferably in the form of a character, such as, an animal as shown in the drawings. The body portion 13 is in the shape of a character body and the shoulder strap members 21 are preferably in the form of character arms as shown in FIG. 4 and the waist strap members 34 which are in the form of character legs or extremities. The tether 45 is preferably in the form of a character tail. The device 11 when placed around the torso of a child or wearer and securely fastened as described is in the form of a character receiving what is known as a “piggy back” ride from the child. The character will have its arms and legs wrapped around the shoulders and waist of the child. The pouch 19 enables a child or adult to place items within the pouch 19 and securely close the pouch 19 with the zipper 30.

The location of the tether loop 47 allows a child or wearer to freely move around, especially in front of an adult, without pulling the child around to face the adult or the party controlling the handle portion 46, which is the case with tethers attached to a front of a harness. In certain desired situations, the loop 47 may be attached to any strap members, including the shoulder straps 21 and the upper and lower straps 23′ and 23. Preferably, the tether loop 47 is attached to the waist strap 34 which prevents the wearer from losing his or her balance if the adult gives a gentle tug on the tether 45. A tether attached to the waist of a child is less likely to cause the child to lose their balance due to the child's center of gravity being located along the torso area.

In use, the harness 11 is placed with the front panel 17 along the back of a child. The shoulder straps 21 are placed over the shoulders of a child and the waist strap 23 is placed around the waist of a child. The lower strap members 34 are secured with the closure member 31 and the upper strap members 34′ also secured with the closure member 31′. The shoulder strap members 21 may be adjusted with the adjustment device 29 and the waist strap 23 may also be adjusted with the adjustment device 32. The tether 45 may then be attached to the harness 11 with the tether loop 47 and the tether hook 49. An adult may then grasp the tether handle 46 to retain control of the child. The child may place toys or other items in the pouch 19 and close it with the zipper 30 to prevent the items from falling out. In this way, a parent may control the movements of the child without fear of losing t he child in a crowded environment. It is also helpful when the adult has numerous children to supervise and allows the adult to keep the children safe and under control with one hand while leaving the adult's other hand free. If desired, the tether 45 may be completely removed so the child may simply wear the device 11 without the tether 45.

It is therefore to be understood that while preferred forms of invention are herein set forth and described, the above and other modifications may be made therein without departing from the spirit and scope of the invention as defined by the appended claims and reasonable equivalents thereof.

We claim:

1. A child's harness comprising:
a fabric shell defining a body portion of a character having a head and pairs of upper and lower limb members extending outwardly from said body portion;
said upper limb members forming shoulder strap members to be worn over the shoulders of a wearer;
said lower limb members forming waist strap members to encircle the waist of a wearer; and
said upper and lower limb members being secured to form a restraint member.

2. A child's harness according to claim 1 wherein said harness includes a detachable tether linked to one of said waist strap members.

3. A child's harness according to claim 1 wherein said detachable tether is in the form of a character tail.

4. A child's harness according to claim 1 wherein said body portion includes a storage pouch.

5. A child's harness according to claim 1 wherein said shoulder straps and said waist strap members include at least one closure member.

6. A child's harness according to claim 1 wherein said shoulder strap members are secured at respective free ends to said waist strap members.

7. A child's harness according to claim 2 wherein said tether is attached to an attachment member secured to said waist strap members.

8. A child's harness according to claim 4 wherein said storage pouch includes a zippered pouch.

9. A child's harness according to claim 4 wherein said storage pouch is located along a back panel of said body portion.

10. A child's harness according to claim 1 wherein a front panel of said body portion is coextensive with a dorsal area of a wearer.

11. A child's harness comprising:
a body member having a back panel, front panel and a storage pouch within said body member, upper shoulder strap members and lower waist strap members extending from said body member forming a restraining unit, said upper shoulder strap members secured at respective free ends to said lower waist strap members, said waist strap members including terminal ends having means for releasably securing said ends around a torso of a wearer; and
said body member defining a character including a head member, torso and limbs.

12. A child's harness according to claim 11 wherein said shoulder strap members are secured to spaced portions of said waist strap members.

13. A child's harness according to claim 11 wherein said shoulder strap members are secured with a second closure member located along an upper portion of said shoulder strap members.

14. A child's harness according to claim 11 wherein said restraining unit forms means for enclosing a wearer within said harness.

15. A child's harness according to claim 11 wherein said body member includes a tether in the form of a character tail.

16. A child's harness comprising:
a fabric shell having a front and back panel, said back panel including an opening into the interior of said shell;
shoulder strap members in the form of character limbs extending forwardly from said body member adapted for extension over the shoulders of a wearer;
lower waist strap members in the form of character limbs extending forwardly from said body member adapted to extend around the waist of a wearer;
terminal ends of said shoulder strap members secured to each end of said waist strap members;
each of said waist strap member ends terminating in a closure member;
said shoulder strap members having means for securing said strap members over the shoulders of a wearer; and
a detachable tether linked to said lower waist strap members.

17. A child's harness according to claim 16 wherein said opening includes a zippered pouch.

18. A child's harness according to claim 16 wherein said shell defines a central body member in the form of a character having a head and at least four limbs forming said shoulder strap members and said waist strap members.

19. A child's harness according to claim 18 wherein said limbs are adapted to wrap around a torso of a wearer.

20. A child's harness according to claim 16 wherein said securing means are spaced above said terminal ends of said shoulder strap members.

21. A combination of a child's harness and backpack for restricting the movement of a child, comprising in combination:
(a) a pair of shoulder strap members having two ends, one of said ends connected to a waist strap member, a second of said ends connected to a body member;
(b) a tether having a looped handle at one end and a connection member at a second end for affixing said second end of said tether to said waist strap member;
(c) said body member having a front and back panel, said back panel including an opening into the interior of said body member, and said body member is defined by a character having a head and at least four limbs forming said shoulder strap members and said waist strap member; and
(d) said waist strap member and said shoulder strap members having releasable securing members, said shoulder strap securing member spaced above said waist strap securing member.
